(19) United States
(12) Patent Application Publication
(10) Pub. No.: US 2025/0391586 A1
(43) Pub. Date: Dec. 25, 2025

(54) Combined Cable

(71) Applicants: Tyco Electronics (Shanghai) Co., Ltd., Shanghai (CN); Tyco Electronics (Dongguan) Ltd., Dongguan City (CN)

(72) Inventors: Zhiwei (Jack) Guo, Dongguan (CN); Chaofeng Wang, Dongguan (CN)

(73) Assignees: Tyco Electronics (Shanghai) Co., Ltd., Shanghai (CN); Tyco Electronics (Dongguan) Ltd., Dongguan City (CN)

(21) Appl. No.: 19/243,885

(22) Filed: Jun. 20, 2025

(30) Foreign Application Priority Data
Jun. 20, 2024 (CN) 202410806739.5

(51) Int. Cl. H01B 7/08; H01B 7/18; H01B 13/00

(52) U.S. Cl. CPC H01B 7/0838; H01B 7/0869; H01B 7/18; H01B 13/0016

(57) ABSTRACT

A combined cable includes a row of cables having a plurality of cables separated from each other in a width direction of the combined cable, each of the cables extending in a length direction of the combined cable, a first film disposed on a side of the row of cables, and a second film disposed on another side of the row of cables opposite the first film in a thickness direction of the combined cable perpendicular to the width direction and the length direction. The first film and the second film are bonded to each of the cables. A portion of each of the first film and the second film between adjacent cables of the row of cables is not bonded together.

### CROSS-REFERENCE TO RELATED APPLICATION

This application claims the benefit of the filing date under 35 U.S.C. § 119 (a)-(d) of Chinese Patent Application No. 202410806739.5, filed on Jun. 20, 2024.

### FIELD OF THE INVENTION

Embodiments of the present disclosure relate to a combined cable.

### BACKGROUND OF THE INVENTION

A flat combined cable typically includes a row of cables arranged in parallel. In related art, a layer of film is usually bonded to one side surface of the row of cables in order to connect the row of cables together. However, this configuration will cause the structure of the combined cable to be extremely unstable, and cables easily fall off and become loose, resulting in unusable assembling. Moreover, hot melt adhesive on the film is exposed to the air and is more susceptible to aging failure due to environmental effect.

### SUMMARY OF THE INVENTION

A combined cable includes a row of cables having a plurality of cables separated from each other in a width direction of the combined cable, each of the cables extending in a length direction of the combined cable, a first film disposed on a side of the row of cables, and a second film disposed on another side of the row of cables opposite the first film in a thickness direction of the combined cable perpendicular to the width direction and the length direction. The first film and the second film are bonded to each of the cables. A portion of each of the first film and the second film between adjacent cables of the row of cables is not bonded together.

### BRIEF DESCRIPTION OF THE DRAWINGS

The invention will now be described by way of example with reference to the accompanying figures, of which:

FIG. 1 is a schematic view showing a combined cable according to an exemplary embodiment of the present disclosure;

FIG. 2 is a schematic partially enlarged view showing the combined cable of FIG. 1;

FIG. 3 is a schematic view showing the combined cable of FIG. 1 in the state of a first film, a second film, and cables being separated;

FIG. 4 is a schematic view showing one cable included in the combined cable of FIG. 1; and

FIG. 5 is a schematic view showing one cable included in a combined cable according to another exemplary embodiment of the present disclosure.

### DETAILED DESCRIPTION

Embodiments of the present disclosure will be described hereinafter in detail taken in conjunction with the accompanying drawings. In the description, the same or similar parts are indicated by the same or similar reference numerals. The description of each of the embodiments of the present disclosure hereinafter with reference to the accompanying drawings is intended to explain the general inventive concept of the present disclosure and should not be construed as a limitation on the present disclosure.

In addition, in the following detailed description, for the sake of explanation, numerous specific details are set forth in order to provide a thorough understanding of the disclosed embodiments. It will be apparent, however, that one or more embodiments may also be practiced without these specific details. In other instances, well-known structures and devices are illustrated schematically in order to simplify the drawing.

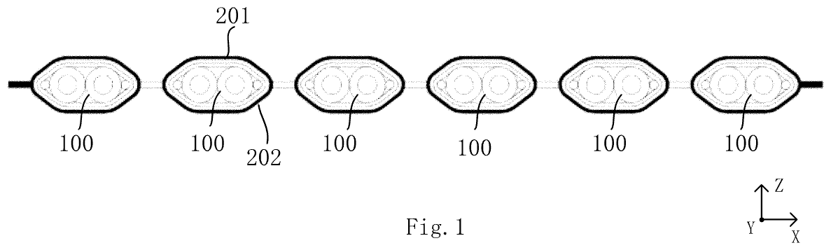

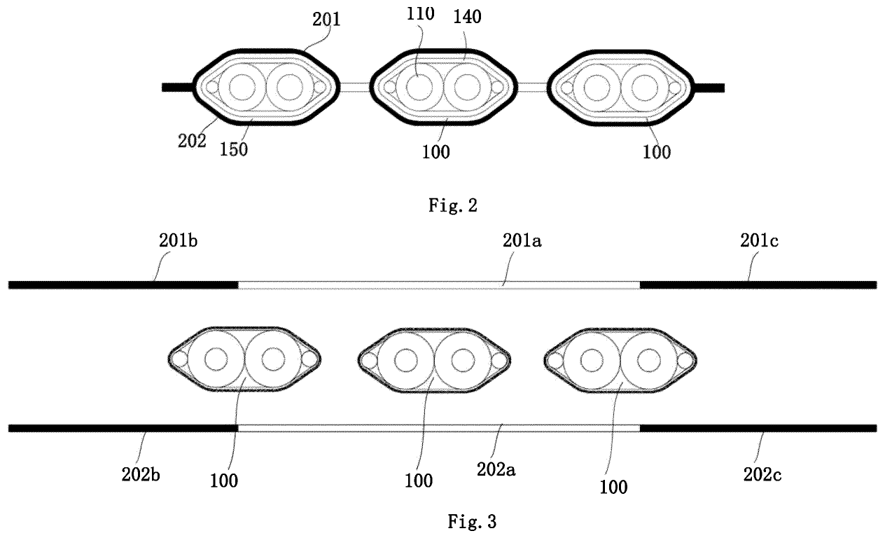

Referring to FIG. 1 and FIG. 2, the combined cable according to an exemplary embodiment of the present disclosure mainly includes a row of cables 100, a first film 201, and a second film 202.

The row of cables 100 includes a plurality of cables 100 separated apart from each other in a width direction X of the combined cable, each cable 100 extending in a length direction Y of the combined cable.

The first film 201 and the second film 202 are provided on opposite sides of the combined cable in a thickness direction Z, respectively, the thickness direction Z being perpendicular to the width direction X and the length direction Y of the combined cable. The first film 201 and the second film 202 are bonded to each cable 100, respectively; and portions of the first film 201 and the second film 202 between adjacent two cables 100 are not bonded together. As shown in FIG. 1, the row of cables 100 has a first side surface (i.e., the upper side surface shown in FIG. 1) and a second side surface (i.e., the lower side surface shown in FIG. 1), wherein the first and second side surfaces are located on the opposite sides of the combined cable in the thickness direction Z, respectively. The first film 201 is bonded to the first side surface of the row of cables 100, and the second film 202 is bonded to the second side surface of the row of cables 100, but portions of the first film 201 and the second film 202 between the adjacent two cables 100 are not bonded together.

In this way, the row of cables 100 may be connected and fixed together by the first film 201 and the second film 202, to improve the defect of the cables 100 easily falling off and becoming loose, thereby enhancing the structural stability of the combined cable. Moreover, since portions of the first film 201 and the second film 202 between the adjacent two cables 100 are not bonded together, the flexibility of the combined cable is improved so as to avoid excessive rigidity of the combined cable which makes it difficult to be bent and thus difficult to be soldered onto a circuit board.

According to an exemplary embodiment of the present disclosure, referring to FIGS. 2 and 3, the first film 201 includes a central part 201a and adhesive parts 201b, 201c located on either side of the central part 201a along the width direction X of the combined cable. Similarly, the second film 202 also includes a central part 202a and adhesive parts 202b, 202c located on either side of the central part 202a along the width direction X of the combined cable. The adhesive part 201b of the first film 201 and the adhesive part 202b of the second film 202 are bonded together on one side of the row of cables 100 along the width direction X of the combined cable. The adhesive part 201c of the first film 201 and the adhesive part 202c of the second film 202 are bonded together on the other side of the row of cables 100 along the width direction X of the combined cable. In this way, the connection stability of the first film 201, the second film 202 and the row of cables 100 may be improved. Moreover, the adhesive of the bonding parts does not contact the external air, and is less affected by the environment, and thus does not lose efficacy as easily.

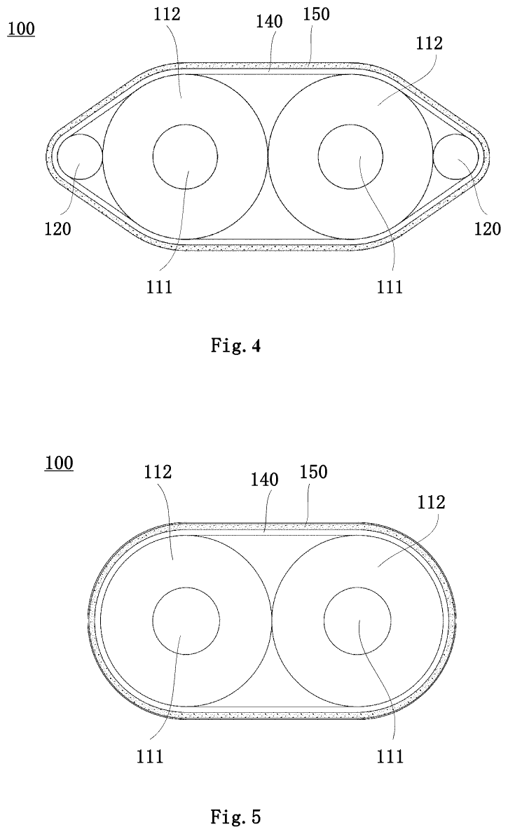

According to an exemplary embodiment of the present disclosure, as shown in FIGS. 2 and 4, each of the cables 100 includes at least one wire 110, 120, a shielding layer 140 wrapped around the at least one wire 110, 120, and an insulation layer 150 wrapped around the shielding layer 140. The insulation layer 150 has a first side surface (i.e., the upper side surface shown in FIG. 4) and a second side surface (i.e., the lower side surface shown in FIG. 4) located on opposite sides of the combined cable along the thickness direction Z, respectively, the first film 201 being bonded to the first side surface of the insulation layer 150, and the second film 202 being bonded to the second side surface of the insulation layer 150, as shown in FIGS. 1 and 2.

According to an exemplary embodiment, the first film 201 and the second film 202 are thermally bonded to the corresponding side surfaces of the insulation layer 150 by hot pressing, respectively. However, in some other embodiments of the present disclosure, the first film 201 and the second film 202 can be bonded to the corresponding side surfaces of the insulation layer 150 by other manners, respectively.

According to an exemplary embodiment of the present disclosure, referring to FIG. 4, an outer surface of the insulation layer 150 is provided with an adhesive, such as a hot melt adhesive, such that the first film 201 and the second film 202 can be bonded to the outer surface of the insulation layer 150. The insulation layer 150 may be, for example, of a hot sealed polyester tape, wherein one side of the hot sealed polyester tape on which the hot melt adhesive is disposed toward the outside so that the first film 201 and the second film 202 can be bonded to the outer surface of the hot sealing polyester tape. The insulation layer 150 may include one, two or more layers, and the adhesive is provided on the outer surface of the outermost layer of the insulation layer 150 when the insulation layer 150 includes multiple layers.

According to an exemplary embodiment of the present disclosure, referring to FIG. 4, the shielding layer 140 of each of the cables 100 includes an inner metal layer and an outer insulation layer bonded to an outer surface of the inner metal layer.

According to an exemplary embodiment of the present disclosure, the at least one wire 110,120 includes a first wire 110 for transmitting signals or electric power. In addition, in this exemplary embodiment, the at least one wire 110,120 may further include a second wire 120 for grounding.

According to an exemplary embodiment of the present disclosure, each of the cables 100 includes two first wires 110 and two second wires 120. It should be noted that, in some other embodiments of the present disclosure, a number of the first wire 110 may be three, four, etc., and a number of the second wire 120 may also be three, four, etc. For example, as shown in FIG. 5, the cable 100 includes only two first wires 110 and no second wire 120. In other words, the type of wires included in the cables of the combined cables and its corresponding number according to the present disclosure shall be specifically designed according to the specific circumstances.

According to an exemplary embodiment of the present disclosure, referring to FIGS. 1 to 4, the two first wires 110 and the two second wires 120 of each of the cables 100 are arranged side by side in one row. According to an exemplary embodiment of the present disclosure, referring to FIGS. 1 to 4, the two first wires 110 of each of the cables 100 are adjacent to each other, and the two second wires 120 of each of the cables 100 are located on opposite sides of the two first wires 110, respectively. That is, the two first wires 110 are located between the two second wires 120.

According to an exemplary embodiment of the present disclosure, referring to FIGS. 1 to 4, each of the first wires 110 includes a conductor 111 and a wire insulation layer 112 wrapped around the conductor 111.

According to an exemplary embodiment of the present disclosure, at least one of the first film 201 and the second film 202 is made of an insulating material. For example, the first film 201 and the second film 202 may be made of polyethylene terephthalate (abbreviated as PET). According to an exemplary embodiment, at least one of the first film 201 and the second film 202 is a shielding film.

According to an exemplary embodiment of the present disclosure, referring to FIGS. 1 to 4, the combined cable is flat, and thus it can be called as a flat cable.

According to the combined cable described in various foregoing exemplary embodiments of the present disclosure, the row of cables arranged in parallel are connected and fixed together by the first film and the second film to improve the defect of internal cables easily falling off and becoming loose, thereby enhancing the structural stability of the combined cable. Moreover, since portions of the first film and the second film between adjacent two cables are not bonded together, the flexibility of the combined cable is improved so as to avoid excessive rigidity of the combined cable which makes it difficult to be bent and thus difficult to be soldered onto a circuit board.

It should be appreciated by those skilled in the art that the above embodiments are intended to be illustrative, and many modifications may be made to the above embodiments by those skilled in the art. Further, various structures described in various embodiments may be freely combined with each other without conflicting in configuration or principle.

Although the present disclosure has been described hereinbefore in detail with reference to the accompanying drawings, it should be appreciated that the disclosed embodiments in the accompanying drawings are intended to illustrate embodiments of the present disclosure by way of example, and should not be construed as a limitation to the present disclosure.

Although some embodiments of the general inventive concept of the present disclosure have been shown and described, it would be appreciated by those skilled in the art that changes or modification may be made to these embodiments without departing from the principles and spirit of the general inventive concept, the scope of which is defined in the claims and their equivalents.

It should be noted that, the word “comprise” or “include” doesn't exclude other elements or steps, and the word “a” or “an” doesn't exclude more than a plurality.

1. A combined cable, comprising:
a row of cables including a plurality of cables separated from each other in a width direction of the combined cable, each of the cables extending in a length direction of the combined cable;
a first film disposed on a side of the row of cables; and
a second film disposed on another side of the row of cables opposite the first film in a thickness direction of the combined cable perpendicular to the width direction and the length direction, the first film and the second film are bonded to each of the cables, a portion of each of the first film and the second film between adjacent cables of the row of cables is not bonded together.

2. The combined cable of claim 1, wherein the first film and the second film each have a central part and a pair of adhesive parts on either side of the central part along the width direction.

3. The combined cable of claim 2, wherein the adhesive parts of the first film and the adhesive parts of the second film are bonded together on either side of the row of cables along the width direction.

4. The combined cable of claim 1, wherein each of the cables has a wire, a shielding layer wrapped around the wire, and an insulation layer wrapped around the shielding layer.

5. The combined cable of claim 4, wherein the insulation layer has a first side surface and a second side surface on opposite sides of the cable along the thickness direction, the first film is bonded to the first side surface and the second film is bonded to the second side surface.

6. The combined cable of claim 5, wherein the first film and the second film are thermally bonded to the first side surface and the second side surface of the insulation layer by hot pressing.

7. The combined cable of claim 5, wherein an outer surface of the insulation layer has an adhesive such that the first film and the second film are bonded to the outer surface of the insulation layer.

8. The combined cable of claim 5, wherein the shielding layer has an inner metal layer and an outer insulation layer bonded to an outer surface of the inner metal layer.

9. The combined cable of claim 5, wherein the wire includes a first wire for transmitting signals or electric power.

10. The combined cable of claim 9, wherein the wire includes a second wire for grounding.

11. The combined cable of claim 10, wherein the first wire is one of a pair of first wires and the second wire is one of a pair of second wires.

12. The combined cable of claim 11, wherein the first wires and the second wires are arranged side by side in a row.

13. The combined cable of claim 12, wherein the first wires of adjacent cables are adjacent to each other.

14. The combined cable of claim 12, wherein the second wires are on opposite sides of the first wires.

15. The combined cable of claim 9, wherein the first wire has a conductor and a wire insulation layer wrapped around the conductor.

16. The combined cable of claim 1, wherein at least one of the first film and the second film is made of an insulating material.

17. The combined cable of claim 1, wherein at least one of the first film and the second film is a shielding film.

18. The combined cable of claim 1, wherein the combined cable is flat.
